(19) United States
(12) Patent Application Publication
(10) Pub. No.: US 2004/0010797 A1
(43) Pub. Date: Jan. 15, 2004

(54) Television audience interaction system

(76) Inventor: Peter S. Vogel, Faulcon Bridge (AU)

Correspondence Address: PETER VOGEL, 30 ADELINE ST., FAULCON BRIDGE, 2776, AU

(21) Appl. No.: 10/601,985

(22) Filed: Jun. 19, 2003

(30) Foreign Application Priority Data
Jul. 1, 2002 (AU) PS3285

(51) Int. Cl. H04N 7/16; H04H 9/00; H04N 7/173

(52) U.S. Cl. 725/24; 725/13; 725/105

(57) ABSTRACT

A systems for inserting feedback from members of the viewing public into a television program. Viewers submit reactions to programming in realtime in the form of spoken messages, text messages, or graphics which are incorporated into the program being watched or into a separate program broadcast subsequently. The invention has many applications in the entertainment industry, including, for example, making television programs more entertaining and creating an extra revenue source for broadcasters.

### FIELD OF THE INVENTION

This invention relates to systems of inserting voice messages from members of the viewing public into a television program.

The present invention has many applications in the entertainment industry, including, for example, making television programs more entertaining and creating an extra revenue source for broadcasters.

### PRIOR ART

It is well known in the television industry to invite the public to respond to or interact with programs, for example by writing letters, sending emails, or making phone calls. For example, the program “Big Brother” relies upon the public to phone in and vote for which people are to be evicted from the show. Other programs use polling via telephone, mail or Internet to provide public opinion statistics. In most cases the broadcaster's objective in providing such facilities is to raise revenue, typically by charging premium rates for telephone calls through mechanisms such as “1900” facilities.

These prior-art audience response systems are generally limited in that they provide only aggregated responses, such as total votes.

### OBJECTS OF THE INVENTION

It is an object of the present invention to provide an audience response system which allows members of the public to send a message to a viewing audience.

It is another object of the present invention to provide an audience response system which allows members of the public to send a message to a viewing audience with sufficiently small time between receipt of message and reproduction to the public to enable the public to respond to the content of a broadcast program as the program unfolds.

In one aspect, the present invention provides a method of receiving voice messages from members of the public and inserting them into a television program.

According to another aspect of this invention, the audience response system as described above further comprises a method of selecting messages so that when messages are being received at a rate greater than the rate at which messages can be inserted into the television program, the rate of insertion is reduced accordingly. Rate-reduction filtering methods which can be usefully utilized by this invention include, amongst others, randomly selecting a subset of messages and discarding the rest, queuing messages for use at a later time as time permits, manual culling of messages by a human operator, or combinations of multiple strategies.

In yet another aspect, the invention further comprises the step of approving messages, to ensure that the content is suitable for broadcast. In some cases this filtering can be performed automatically by a computer programmed to recognize certain words or phrases and discard messages that breach certain rules. In other cases, a computer can perform a first level of filtering, directing messages that breach certain rules to a human approval operator for final approval or rejection. In yet other cases, approval can be a purely manual process. To minimize labor required in this latter case, messages can be submitted to the approval operator after the rate reduction method has been applied.

According to certain aspects of the invention, the message is inserted at the television transmission station, in which case the selected message is heard by anyone watching the program. In this case, no extra equipment is required for home viewers to hear the messages. In other aspects, the message is inserted at the viewer's home, using equipment designed for that purpose. In this case, the message can be conveyed to the viewer's home by a suitable communications medium, for example the Internet, subcarrier of an FM radio broadcast, a radio signal specifically for the purpose, a radio-paging service, or encoded into the television signal being received. To reduce the cost to the viewer, the invention can use a conventional broadcast radio receiver as the message receiver in the home.

According to another aspect, the invention is further adapted to gather statistical information from messages received. For example, the system can tally votes on a particular question as messages are received, so that in addition to the chance of having their message appear on TV, callers have the benefit of registering a vote. Voting data can be captured by using different phone numbers for different choices, by leading the caller through a voice menu and requesting tone dialing entry of voting, by speech recognition software, by human monitoring, or other well-known techniques. Ongoing tallies can also be forwarded automatically to suitable equipment for insertion into a program as it goes to air, in written form or spoken form or both.

According to another aspect, the invention further comprises the step of charging the sender for sending a message. Alternatively, the sender may be charged only if his or her message is ultimately selected for transmission, or the amount charged can be a first amount for receiving the message at the message receiving station and a second amount if the message is selected for transmission.

In yet another aspect, the invention is further adapted so that the probability of a particular message being selected for insertion into the program is proportional to the amount paid by the sender. This aspect of the invention is particularly useful in cases where the invention is used to facilitate fund raising, such as in a “telethon”.

The invention also consists in apparatus adapted to perform the steps of the inventive methods described herein.

### PREFERRED EMBODIMENT

Some preferred embodiments of the invention will now be described with reference to the drawings in which:

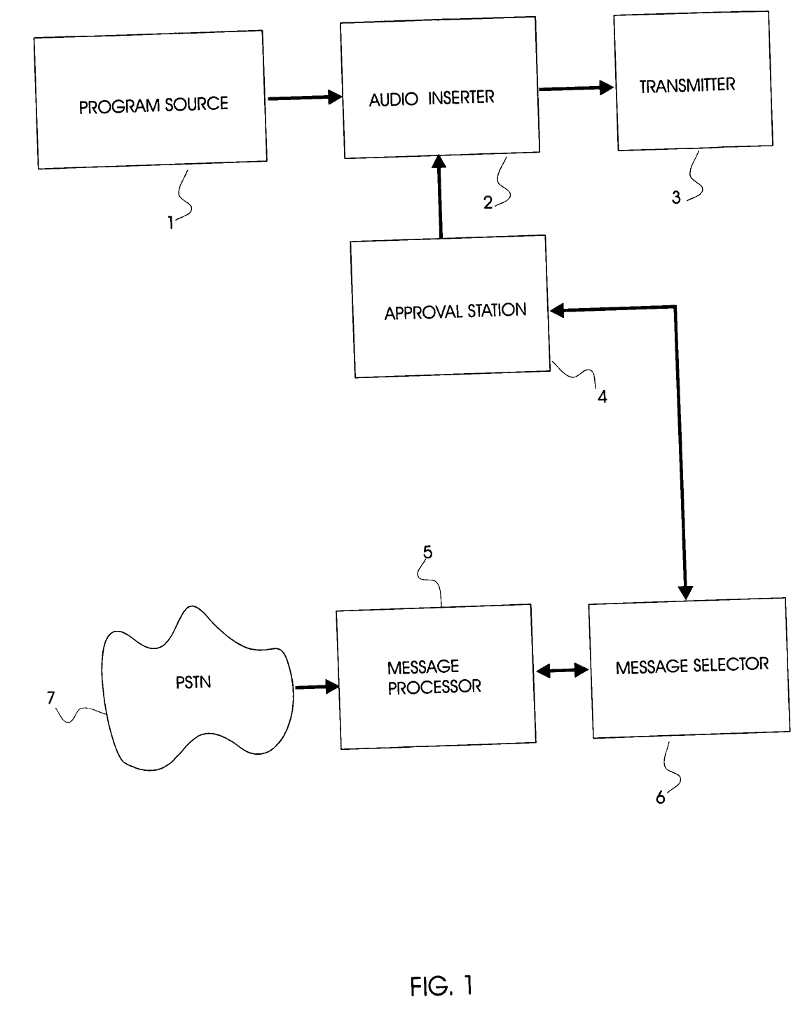

FIG. 1. is a block diagram of the invention wherein the audience response messages are inserted at the program transmission station; and

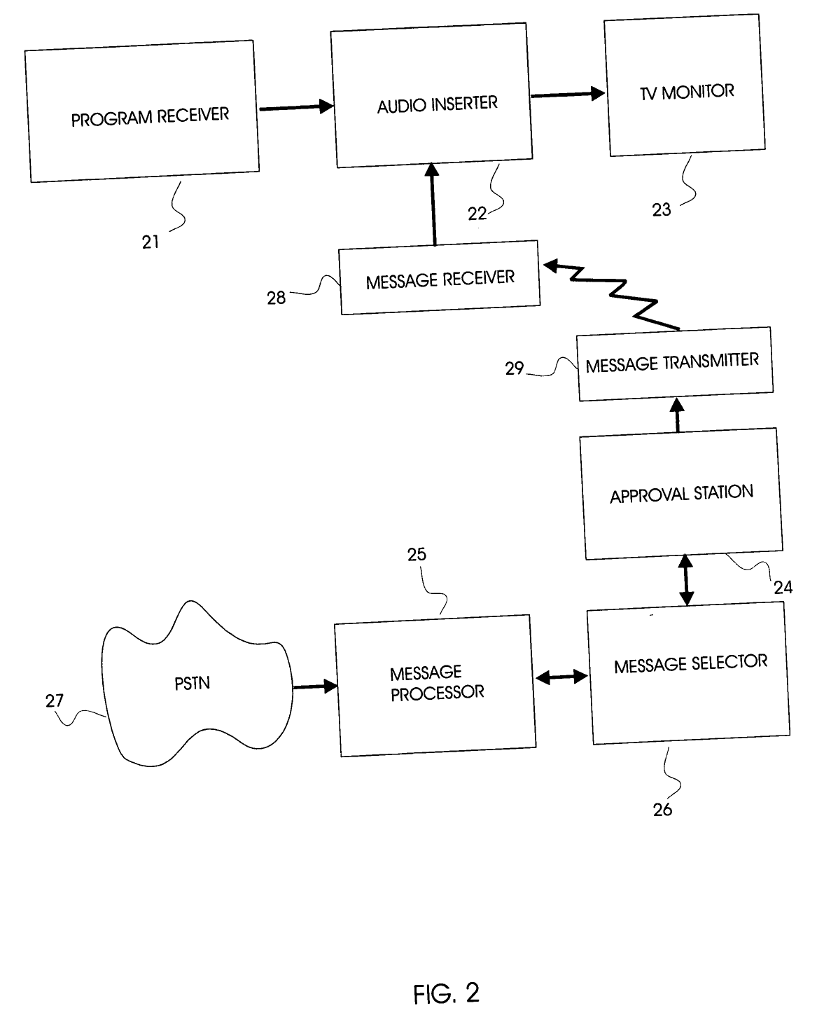

FIG. 2 is a block diagram of the invention wherein the audience response messages are inserted at the program receiving station.

Referring now to FIG. 1, the embodiment shown inserts messages submitted by members of the public into the audio portion of the program being transmitted.

In this embodiment, messages can be submitted to the broadcaster via Public Switched Telephone Network PSTN (7) which feeds message receiver (5). Message receiver (5) translates each message received into a suitable digital format, creating message files which are stored in a suitable memory system. Message submission is charged to the submitter by well-known means, for example by means of premium charges on telephone accounts, or by credit card payment.

When the program being broadcast reaches a point at which a viewer response message is to be inserted, an operator at approval station (4) presses a button that sends a signal to message selector (6) which requests a message from message receiver (5). Message receiver (5) responds by choosing the most recent message filed and sends it to message selector (6). Message receiver (5) deletes the sent message from its memory, and also deletes some of the older messages stored, for example if the total number of messages stored exceeds twenty messages, or if messages are more than two minutes old.

Message selector (6) then sends the selected message to approval station (4), where a human operator auditions the message for suitability. Criteria for approving a message may include non-offensive language, humor, relevance etc.

If the operator approves the message, it is sent to audio inserter (2). If the operator rejects the message, message selector (6) requests another one from message receiver (5).

Audio inserter (2) then inserts the message into the audio portion of the program provided by program source (1) and the program, with message inserted, is then sent to transmitter (3) which broadcasts it via the usual means, such as cable, broadband Internet, or radio transmission.

Referring now to FIG. 2, an embodiment of the invention is shown in which the messages are inserted at the program receiving station. Messages are received and processed at a central office in the same manner as the embodiment described in FIG. 1 by PSTN (27), message receiver (25), message selector (26) and approval station (24). Approved messages in this embodiment are transmitted by message transmitter (29) to message receiver (28), which is one of many such receivers located at viewers' homes. Program receiver (21) and TV monitor (23) are the receiving, sound reproducing and display components of a conventional television receiver. Audio inserter (22) inserts messages received by message receiver (28) into the audio being reproduced.

A variety of transmission media can be utilized with good results for message transmitter (29) and message receiver (28). For example, the transmission medium can be a radio signal, such as a radio paging network, a carrier conveyed on a cable TV network, or a subcarrier of an FM radio broadcast. One convenient system of implementing this part of the invention is to use the vertical interval of the television signal to convey the message by digitizing the audio.

One useful variation of this embodiment utilizes a conventional radio broadcasting transmitter as message transmitter (29) and a conventional radio broadcast receiver as message receiver (28). In this case, the home viewer receives the audience response messages simply by tuning a conventional radio receiver to the appropriate radio station. The only additional equipment required to realize this embodiment, other than conventional television and radio broadcasting and receiving apparatus, is the extra equipment at the radio broadcasting station to receive, store, select and approve messages received by phone. It is a requirement that this equipment allow messages to be processed very rapidly to minimize delay between reception from the caller and transmission to viewers.

Some exemplary applications of this invention will now be described to further assist with understanding the process of the invention.

In one application, the invention is applied to a “reality TV” program such as Big Brother, Temptation Island, or Survivor. Being unscripted, it is the nature of such programs to have periods of silence or little activity. During these periods, the invention can be used to insert comments from the public.

The public is invited to phone in their messages via a “1900” number, which is charged at a premium call rate. The message processor of the invention receives each phone call and stores the message in memory after digitizing. The caller is led through a menu system which allows messages to be recorded, played back, and corrected if the caller so desires. Messages may also be submitted in text form via the Internet or cellphone SMS, in which case they are subsequently converted to audio by text-to-speech software or by a human announcer.

An indicator on the approval station's screen shows the approval operator when the first message has been stored. The operator then listens to the message, and decides whether the message is to be accepted. Messages containing offensive language are not accepted, and preference is given to messages that are humorous and relevant to the action taking place in the program being broadcast. Once the operator has approved a message, it is stored until required to fill a space in the audio of the program. The system then locates the message most recently stored and sends it to the approval station, and the process is repeated.

Because messages will usually be received at a rate far greater then they can be used, callers have only a small chance of their message being broadcast, so that this process is akin to a game of chance. The more frequently a caller places a message call, the greater the chance of having his or her message accepted. If desired, the system can also allow for multiple message reception without repeated calling. For example the voice menu guidance system can ask the caller to key in a number corresponding to how many times he wants his message repeated, for which he is charged accordingly. A message repeated in this way would have proportionately greater chance of being displayed.

The approvals system can be further enhanced by allowing the operator to assign a rating to each message accepted and arranging the system so that higher-rated messages take priority over lower rated ones if there are more messages than can be displayed.

In another exemplary application, messages are rated and stored along with a text representation of the message, as entered by an operator or by speech recognition software. The first 30 second spot in each commercial break is used to display the text of the chosen messages, accompanied by the sound of the message as filed by the invention. Because there is typically a few minutes' delay between receipt of messages and their display, there is sufficient time to enhance the message display, for example by editing the text or adding graphics, backing music or sound effects.

Whereas selection of messages according to the foregoing embodiments of the invention is performed by utilizing the last message received at the moment that a message is required, it will be understood that other strategies for selection can be utilized without departing from the scope of this invention. For example, a random selection can be made within certain parameters, such as random selection of one of the last 10 messages received, or selection of a message received within the last minute. The strategy selected will be determined by the nature of the program to which callers are responding, the statistical outcomes desired to make the process appealing to callers, revenue potential, and other factors.

It will also be understood that whereas the present invention is described herein as receiving messages via telephone, the invention can also be implemented using other forms of message conveyance. For example, messages could be received via the Internet, using digitized audio, or text-to-speech techniques.

Furthermore, it is anticipated that messages can be displayed as text on the screen as well as, or as an alternative to, audible message insertion. For example, received messages can be inserted as scrolling text at the bottom of the program's picture, following the method commonly utilized in “news tickers”.

Whereas the invention is described herein as inserting messages into a program, it is also envisaged that the invention can be used to insert voice messages during commercial breaks. In some embodiments, the home viewer can switch the messages on or off.

Furthermore, whereas the invention is described herein as inserting messages into television programs, it will be obvious to those skilled in the art that the inventive concept can also be applied to inserting voice messages into radio programs.

1. An audience interaction method comprising the steps of:
a) receiving a first message from a member of the audience of an electronic entertainment program; and
b) inserting a second message based on said first message into said electronic entertainment program.

2. The method of claim 1 wherein said electronic entertainment program is a television program.

3. The method of claim 1 wherein said electronic entertainment program is a radio program.

4. The method of claim 1 wherein said electronic entertainment program is an Internet-delivered multimedia program.

5. The method of claim 1 wherein said first message comprises at least an audio message.

6. The method of claim 1 wherein said first message comprises at least a text message.

7. The method of claim 1 wherein said first message comprises at least a visual image.

8. The method of claim 1 wherein said second message comprises at least an audio message.

9. The method of claim 1 wherein said second message comprises at least a text message.

10. The method of claim 1 wherein said second message comprises at least a visual image.

11. The method of claim 1 wherein said first message is received via telephone.

12. The method of claim 1 wherein said first message is received via cellphone SMS.

13. The method of claim 1 wherein said first message is received via Internet.

14. An audience interaction method comprising the steps of:
a) receiving an audio message from a member of the audience of an electronic entertainment program;
b) converting said audio message into a text message;
c) inserting said text message into said electronic entertainment program.

15. An audience interaction method comprising the steps of:
a) receiving a text message from a member of the audience of an electronic entertainment program;
b) converting said text message into a spoken message;
c) inserting said spoken message into said electronic entertainment program.

16. The method of claim 1-15 further comprising the step of queuing received messages for use at a later time.

17. The method of claim 1-15 wherein said received messages are presented to a human operator who selects messages to be discarded.

18. The method of claim 1-15 wherein said received messages are filtered by computational means adapted to discard unsuitable messages.

19. The method of claim 1-15 wherein if said messages are received at a rate above a predetermined rate some messages are automatically discarded.

20. The method of claim 1-15 wherein said messages are inserted at the television transmission station.

21. The method of claim 1-15 wherein said messages to be inserted are conveyed to the viewer's home via the Internet and are inserted at the viewer's home.

22. The method of claim 1-15 wherein said messages to be inserted are conveyed to the viewer's home via coding within a television signal and are inserted at the viewer's home in visual form.

23. The method of claim 1-15 wherein said messages to be inserted are conveyed to the viewer's home via coding within a television signal and are inserted at the viewer's home in audible form.

24. The method of claim 1-15 wherein said messages to be inserted are conveyed to the viewer's home via a radio broadcast and are inserted into a television program being viewed at the viewer's home.

25. The method of claim 1-15 wherein said messages to be inserted are conveyed to the viewer's home via a radio broadcast and are reproduced as a separate audio signal.

26. The method of claim 1-15 further comprising the step of generating statistical information from messages received.

27. The method of claim 1-15 further comprising the step of charging for each message received.

28. The method of claim 1-15 further comprising the step of charging for each message received and inserted.

29. The method of claim 1-15 further comprising the step of charging a first amount for each message received and a second amount for each message inserted.

30. The method of claim 1-15 wherein only a subset of messages received are inserted and the probability of a particular message being inserted is proportional to an amount paid by the person submitting said message.

31. The method of claim 1-15 wherein said received messages are presented to a human operator who assigns a rating to each message accepted and higher-rated messages are inserted in priority to lower-rated messages.

32. A method of creating a television program comprising the steps of:
a) Receiving at least one message from at least one member of the audience of an electronic entertainment program;
b) Converting the messages into a television program; and
c) Transmitting said television program.

33. The method of claim 32 wherein said television program is transmitted by insertion into said electronic entertainment program.

34. The method of claim 32 wherein said television program is transmitted after the conclusion of said electronic entertainment program.
